(19) United States
(12) Patent Application Publication
(10) Pub. No.: US 2024/0362682 A1
(43) Pub. Date: Oct. 31, 2024

(54) INFORMATION PROCESSING DEVICE, CONTENT DISPLAY SYSTEM, AND INFORMATION PROCESSING METHOD

(71) Applicant: Sharp NEC Display Solutions, Ltd., Tokyo (JP)

(72) Inventor: Akira UCHIYAMA, Tokyo (JP)

(21) Appl. No.: 18/771,131

(22) Filed: Jul. 12, 2024

Related U.S. Application Data
(63) Continuation of application No. PCT/JP2022/002368, filed on Jan. 24, 2022.

(51) Int. Cl. G06Q 30/0251; B60L 53/30

(52) U.S. Cl. CPC G06Q 30/0266; B60L 53/305; B60L 2250/16

(57) ABSTRACT

An information processing device includes a detection unit configured to detect an object that has entered a target area from a captured image of a charging station, an estimation unit configured to estimate attributes according to the detected object, a calculation unit configured to allocate contents according to the attributes to at least one period among an intermediate period that is a part of a vehicle stop period in which a vehicle stops in the target area for replenishment of an energy source, a first period including a period from at least a replenishment start time Ts2, which is a time between a start time Ts1 of the vehicle stop period and a first time T1, to the first time T1, between the start time Ts1 and the first time T1, that is a start time of the intermediate period, and a second period that includes at least a period from a second time T2, which is an end time of the intermediate period, to an end time Tel of the vehicle stop period, and an image processing unit configured to cause the allocated contents to be displayed on a display screen in the vehicle stop period.

### TECHNICAL FIELD

The present invention relates to an information processing device, a content display system, and an information processing method.

### BACKGROUND ART

There is a technology that selects and displays the optimal advertising content to a viewer from a plurality of advertising contents displayed on a display device. This is called targeted signage. Targeted signage, in a broad sense, refers to a system that extracts and displays personalized advertising content to a viewer, but there are a wide variety of forms in a narrow sense.

For example, Patent Document 1 discloses a signage system that targets consumers visiting a gas station, and analyzes information on the consumers, types of vehicles they have been on board when they visit the store, and the like, and analyzes hobbies and preferences of the consumers.

### CITATION LIST

### Patent Literature

[Patent Literature 1]
Japanese Unexamined Patent Application, First Publication No. 2019-164635

### SUMMARY OF INVENTION

### Technical Problem

Patent Document 1 has a target signage for consumers who come to a store for a purpose of refueling or charging their cars, and, that is, is characterized by information processing that extracts a type of an advertisement.

However, when a product promoted by an advertisement can be purchased within a time required to charge the electric vehicle or is a product that would benefit consumers if purchased within that time, it is preferable that a timing for causing content of an advertisement and the like to be displayed be at a time point at which there is a lot of leisure time remaining while the electric vehicle is charged.

Therefore, when content is displayed using the charging period, it is preferable to be able to display contents according to the attributes of a target while taking an elapsed time into consideration.

### Solution to Problem

According to one aspect of the present invention, an information processing device includes a detection unit configured to detect an object that has entered a target area from a captured image of the target area of a charging station, an estimation unit configured to estimate attributes according to the detected object, a calculation unit configured to allocate contents according to the attributes to at least one period among an intermediate period that is a part of a vehicle stop period in which a vehicle stops in the target area for replenishment of an energy source, a first period including a period from at least a replenishment start time Ts2, which is a time between a start time Ts1 of the vehicle stop period and a first time T1, to the first time T1, between the start time Ts1 and the first time T1, that is a start time of the intermediate period, and a second period that includes at least a period from a second time T2, which is an end time of the intermediate period, to an end time Te1 of the vehicle stop period, and an image processing unit configured to cause the allocated contents to be displayed on a display screen of a display unit provided at a position corresponding to the target area in the vehicle stop period.

In addition, according to another aspect of the present invention, a content display system includes an information processing device and a display device provided at a charging station, in which the information processing device includes a detection unit configured to extracts a target area from a captured image of a charging station and detect an object that has entered a target area, an estimation unit configured to estimate attributes according to the detected object, a calculation unit configured to allocate contents according to the attributes to at least one period among an intermediate period that is a part of a vehicle stop period in which a vehicle stops in the target area for replenishment of an energy source, a first period including a period from at least a replenishment start time Ts2, which is a time between a start time Ts1 of the vehicle stop period and a first time T1, to the first time T1, between the start time Ts1 and the first time T1, that is a start time of the intermediate period, and a second period that includes at least a period from a second time T2, which is an end time of the intermediate period, to an end time Te1 of the vehicle stop period, and an image processing unit configured to cause the allocated contents to be displayed on a display screen of a display device provided at a position corresponding to the target area in the vehicle stop period, and the display device has a display unit that displays content output from the information processing device.

Moreover, according to still another aspect of the present invention, an information processing method executed by a computer includes detecting an object that has entered a target area from a captured image of the target area of a charging station, estimating attributes according to the detected object, allocating contents according to the attributes to at least one period among an intermediate period that is a part of a vehicle stop period in which a vehicle stops in the target area for replenishment of an energy source, a first period including a period from at least a replenishment start time Ts2, which is a time between a start time Ts1 of the vehicle stop period and a first time T1, to the first time T1, between the start time Ts1 and the first time T1, that is a start time of the intermediate period, and a second period that includes at least a period from a second time T2, which is an end time of the intermediate period, to an end time Te1 of the vehicle stop period, and causing the allocated contents to be displayed on a display screen of a display unit provided at a position corresponding to the target area in the vehicle stop period.

### Advantageous Effects of Invention

According to this disclosure, when content is displayed using a charging period, it is possible to display content according to attributes of a target while taking elapsed time into consideration.

### BRIEF DESCRIPTION OF DRAWINGS

FIG. 1 is an external perspective view which describes an outline of a charging station S in which an information processing device according to the present embodiment is used.

FIG. 2 is a schematic block diagram which describes a configuration of an imaging device 1 and a display device 2.

FIG. 3 is a diagram which shows an example of a correspondence table.

FIG. 4 is a conceptual diagram which describes a period for allocating content.

FIG. 5 is a diagram which shows an example of content storage data stored in a content storage unit 27.

FIG. 6 is a flowchart which describes an operation of a display device 2.

FIG. 7 is a diagram which describes a flow from content extraction to display time setting.

FIG. 8 is a schematic block diagram which describes a configuration of an imaging device 1 and a display device 2A in a second embodiment.

FIG. 9 is a flowchart which describes an operation of the display device 2A in the second embodiment.

FIG. 10 is a functional block diagram which describes a function of an information processing device 3 in a third embodiment.

FIG. 11 is a functional block diagram which describes a function of a content display system in a fourth embodiment.

### DESCRIPTION OF EMBODIMENTS

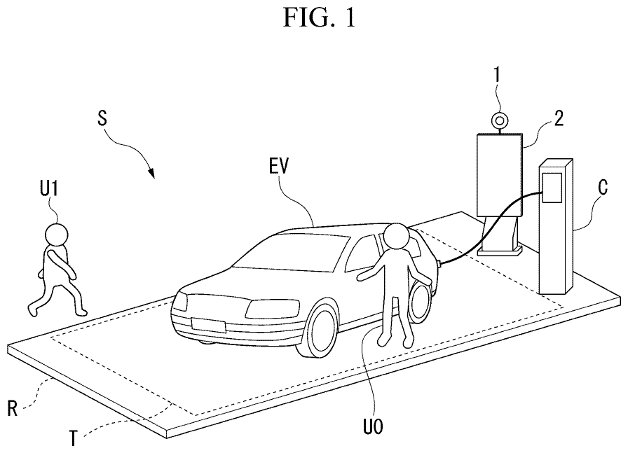

FIG. 1 is an external perspective view which describes an outline of a charging station S in which an information processing device according to the present embodiment is used.

The charging station S includes an imaging device 1, a display device 2, and a charger C. A system in which imaging device 1 and display device 2 are combined is also called a signage system.

The charging station S has a stop area T. The imaging device 1, the display device 2, and an energy supply source are provided in a vicinity of the stop area T. The energy supply source supplies an energy source to a supply target. The supply target is, for example, a vehicle. An energy source of the vehicle may be at least one of electricity, gasoline, and hydrogen. The energy supply source only needs to be able to supply at least one of electricity, gasoline, and hydrogen to the vehicle. In this embodiment, the energy supply source is a charger, which charges a storage battery mounted on the vehicle by supplying power. Note that the energy supply source may be a gasoline supply device, and it supplies gasoline to a gasoline tank of a vehicle in this case. The energy supply source may be a hydrogen supply device, and it supplies hydrogen to a hydrogen tank of a fuel cell vehicle in this case.

The imaging device 1, the display device 2, and the charger C may be provided inside the stop area T.

The stop area T is an area where an electric vehicle EV, which is a vehicle to be charged using electric power supplied from the charger C, can be stopped. When a vehicle has entered the stop area T, it is estimated that the vehicle is entering with a purpose of being charged by the charger C, so that the vehicle that has entered is a vehicle whose battery can be charged at least by the charger C, for example, the electric vehicle EV.

The charger C supplies power to the electric vehicle EV to be charged, and charges the battery mounted on the electric vehicle EV.

The electric vehicle EV is equipped with the battery, and uses electric power supplied from the battery to drive a motor for traveling and travel.

The imaging device 1 images at least an imaging area R that is an area inside the stop area T, and outputs a result of the imaging to the display device 2. The imaging area R imaged by the imaging device 1 may be the same area as the stop area T, or may be an area including the stop area T and an outer periphery of the stop area T. In FIG. 1, the imaging area R is an area outside the stop area T, but is set to approximately the same size as the stop area T.

The display device 2 displays various contents. The display device 2 is provided at a position corresponding to the stop area T. The position corresponding to the stop area T may be any position as long as the display screen of the display device 2 can be visually recognized from at least a user U0 who is in the stop area T. For example, the display device 2 may be located inside the stop area T or may be located in the vicinity of the stop area T. In FIG. 1, a case where the display device 2 is provided at a position adjacent to the stop area T is shown.

The display screen of the display device 2 can be visually recognized by at least a user in the stop area T. For example, the user U0 who has been on board the electric vehicle EV moves in the stop area T when the user may get off the electric vehicle EV, hold a charging connector of the charger C, and connect it to the electric vehicle EV to charge it, or disconnect the charging connector from the electric vehicle EV after charging is completed, and return it to the charger C. At this time, the user U0 can visually recognize the display screen of the display device 2.

Moreover, the display screen of the display device 2 can also be visually recognized from the vicinity of the stop area T. For this reason, the display screen of the display device 2 can also be visually recognized by a user U1 who is moving in the vicinity of the stop area T.

The display device 2 analyzes the imaging data received from the imaging device 1, extracts advertising content according to attributes of a user from a plurality of internally held advertising contents, and sets a display order of the extracted advertising contents.

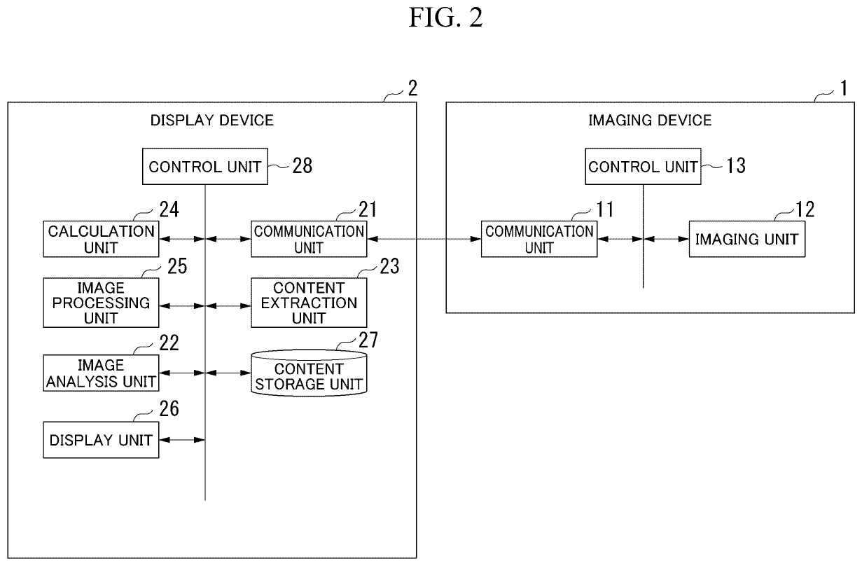

FIG. 2 is a schematic block diagram which describes a configuration of the imaging device 1 and the display device 2.

The imaging device 1 and the display device 2 are communicatively connected to each other.

The imaging device 1 includes a communication unit 11, an imaging unit 12, and a control unit 13.

The communication unit 11 is communicatively connected to the communication unit 21 of the display device 2. Communication between the communication unit 11 and the communication unit 21 may be performed as long as they are able to transmit or receive image data and control commands to or from each other. In addition, the communication between them may be connected by wire and using a protocol based on wired communication, or may be connected wirelessly and by using a protocol based on wireless communication.

The imaging unit 12 images a range including the imaging area R.

The control unit 13 detects whether a vehicle has entered the stop area T on the basis of the image captured by the imaging unit 12. When it is detected that a vehicle has entered the stop area T, the control unit 13 transmits image data at the time of the detection to the display device 2 via the communication unit 11.

The display device 2 includes a communication unit 21, an image analysis unit 22, a content extraction unit 23, a calculation unit 24, an image processing unit 25, a display unit 26, a content storage unit 27, and a control unit 28. The communication unit 21, the image analysis unit 22, the content extraction unit 23, the calculation unit 24, the image processing unit 25, and the control unit 28 may be configured by electronic circuits, and these functions may also be realized by a central processing unit (CPU) installed in the display device 2 reading a software program for realizing these functions from a storage device and executing it.

The communication unit 21 communicates with the communication unit 11 of the imaging device 1 and receives imaging data.

The image analysis unit 22 detects an object that has entered a target area of the charging station (for example, the stop area T) from a captured image, which is obtained by imaging the target area, on the basis of the imaging data acquired from the imaging device 1. An object is at least one of a vehicle (for example, the electric vehicle EV) and the user U0 who has gotten off the vehicle. More specifically, when it is detected that a vehicle has entered the stop area T, the control unit 13 sets the vehicle as an object to be detected and detects that the vehicle has entered a parking lot (the stop area T) within the imaging area R. A determination reference for detecting presence of the vehicle may be, for example, detecting presence or absence of an accessory attached to the vehicle. The accessory to be detected may be, for example, at least one of a license plate, a vehicle inspection sticker, an emblem, and the like. For example, a license plate is generally attached to a vehicle, so that the vehicle can be used as a detection determination reference.

After the vehicle is detected, the image analysis unit 22 detects whether the user U0 has gotten off the vehicle.

Moreover, the image analysis unit 22 has an estimation function that estimates attributes of the detected object. When the attributes are estimated, the image analysis unit 22 estimates the attributes on the basis of at least one of the vehicle that has entered the target area, the accessory attached to the vehicle, and the face of a passenger of the vehicle. The passenger may be any person who is on board the vehicle, and may be a person in the driver's seat, a person in the front passenger seat, or a person in the back seat. Here, when the vehicle enters the stop area T, there is at least a person in the driver's seat, so that the attributes of the person in the driver's seat may be estimated. When the attributes of a passenger are estimated, the image analysis unit 22 extracts a facial image of the passenger from the captured image and estimates the attributes of the passenger on the basis of this facial image.

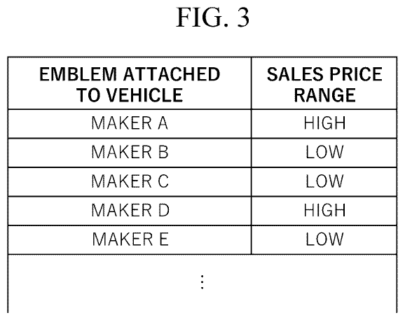

Here, FIG. 3 is a diagram which shows an example of a correspondence table. This correspondence table may be stored in a storage area within the image analysis unit 22, or may be stored in a storage device provided within the display device 2.

The correspondence table is data in which a type of an emblem attached to a vehicle is associated with a sales price range. An emblem varies depending on a manufacturing vendor of the vehicle. In addition, the emblem may be different for each vehicle type. For example, the emblem may be a shape representing a manufacturer of a vehicle, a shape representing a vendor, a shape representing a type of a vehicle, or a shape representing a grade of a vehicle determined for each vehicle type. For example, the emblem representing a manufacturer, the emblem representing a type of a vehicle, and the emblem representing a grade are attached as the emblem, and the image analysis unit 22 detects these emblems. When a plurality of emblems are attached to a single vehicle, the emblem representing a manufacturer may be provided at a front of the vehicle, and the emblem representing a type of a vehicle and the emblem representing a grade may be provided at a rear of the vehicle. In such a case, the image analysis unit 22 may detect an emblem from a single vehicle using a plurality of images captured from different angles of the single vehicle.

The image analysis unit 22 reads out the sales price range corresponding to the detected emblem with reference to the correspondence table. In this manner, the image analysis unit 22 can identify the manufacturing vendor of a vehicle and the grade of a vehicle by analyzing the accessory of a vehicle, and can refer to the correspondence table on the basis of a result of the identification and analyze an approximate price range of a vehicle to be analyzed.

In addition, the image analysis unit 22 estimates the attributes of a user on the basis of an image of the face of the user who gets off a vehicle and performs an operation on a console of a charging stand when charging starts. The attributes to be estimated are, for example, age and gender. When the attributes of the user are estimated, the image analysis unit 22 compares learning data of the display device 2 with information of the captured facial image of the user, and estimates the age and gender of the user. For example, the image analysis unit 22 can obtain the attributes from a trained model by inputting the captured facial image to the trained model that has learned a relationship between the facial image and the attributes.

On the basis of a result of the analysis obtained by the image analysis unit 22, the content extraction unit 23 extracts advertising content according to the age and gender of a user, and a price range of a luxury item (a vehicle) from the content storage unit 27. Content may be a video or a still image.

The calculation unit 24 allocates contents according to the attributes to a vehicle stop period in which a vehicle stops for replenishment of an energy source in a target area.

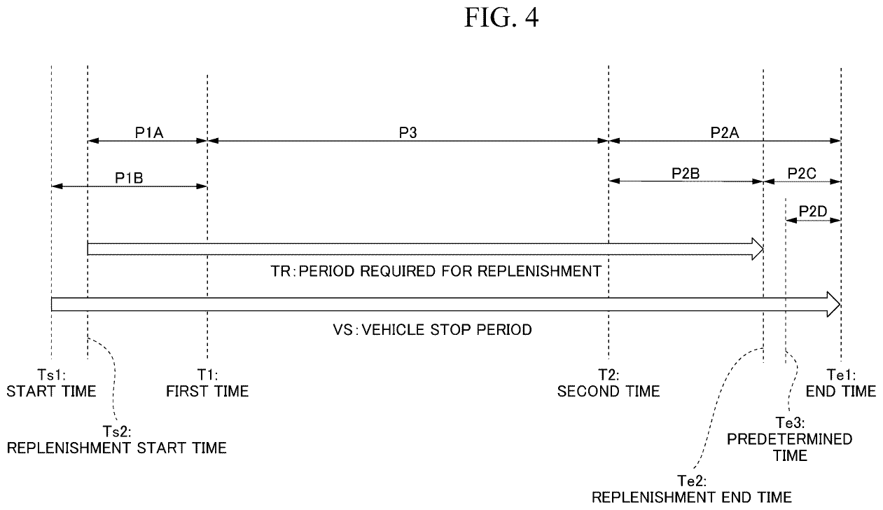

Here, FIG. 4 is a conceptual diagram which describes a period to which content is allocated. A vehicle stop period is a period in which a vehicle is stopped and the energy source can be replenished. For example, a vehicle stop period is a period in which a vehicle stops for the replenishment of an energy source in a target area. The target area may be any area where a vehicle can stop and replenish the energy source, for example, the stop area T.

The vehicle stop period VS is a period from a start time Ts1, which is a time when a vehicle has stopped, to an end time Te1, which is a time when the vehicle stops stopping (starts to move).

A period required for replenishment TR is at least a part of the vehicle stop period VS, and is a period for replenishing the energy source of the vehicle. Here, the period required for replenishment TR is a period from a replenishment start time Te1 to a replenishment end time Te2.

At the charging station, there is a period until the passenger gets off the vehicle, takes out the charging connector of the charger C, and connects the charging connector to a charging terminal of the electric vehicle EV after the electric vehicle EV stops in the stop area T. For this reason, the period required for replenishment TR may start after the vehicle stop period VS starts and a preparation period for charging elapses.

Additionally, there is a period until the charging connector is removed from the electric vehicle EV and is returned to the charger C after the period required for replenishment TR ends due to an end of charging. For this reason, the end time Te1 of the vehicle stop period VS may arrive after the vehicle stop period VS ends and the preparation period due to the end of charging elapses.

The period required for replenishment is an estimated period, and the replenishment start time Te1 and the replenishment end time Te2 may also be estimated times. The estimation of the replenishment start time Te1 and the replenishment end time Te2 may be performed by the calculation unit 24 of the display device 2. The calculation unit 24 may estimate the replenishment start time Te1 and the replenishment end time Te2 on the basis of a general time or an average time required for the charging of an electric vehicle. Moreover, the calculation unit 24 may acquire a period required for replenishment determined by the charger C in response to the connection of the charging connector to the electric vehicle EV, and determine the replenishment start time Te1 and the replenishment end time Te2 on the basis of this time required for replenishment. When the period required for replenishment is acquired, the calculation unit 24 may receive the period required for replenishment from the charger C according to communication via the communication unit 21, or may acquire the period required for replenishment displayed on the display screen of the charger C by reading it from the captured image of the imaging device 1.

In this embodiment, a case in which the period required for replenishment is approximately 30 minutes will be described as an example.

A replenishment start time Ts2 is a time when the charger C starts charging for a battery of the electric vehicle EV, and the replenishment end time Te2 is a time when the charger C ends the charging of the battery of the electric vehicle EV. Here, a time at which charging is started may be a time when a power supply to the battery of the electric vehicle EV is actually started from the charger C, or may include a preparation time for the passenger to perform charging (a time for performing an operation of connecting the charging connector to the electric vehicle EV, and performing various operations for causing the charger C to start charging, and the like) until charging is actually started after the vehicle enters the stop area T.

The calculation unit 24 allocates contents according to the attributes to at least one of an intermediate period (hereinafter referred to as a third period) P3, a first period P1, and a second period P2.

A third period P3 is a part of the vehicle stop period VS in which the vehicle stops in the target area for the replenishment of the energy source. Here, the third period P3 corresponds to a part of the period required for replenishment TR. The third period P3 is a period between the first time T1 and the second time T2.

The first time T1 is a time later than the replenishment start time Ts2. The second time T2 is a time later than the first time T1 and prior to the replenishment end time Te2.

The first period P1 is a period that includes at least a period from the fuel replenishment start time Ts2, which is a time between the start time Ts1 and the first time T1, to the first time T1 between the start time Ts1 of the vehicle stop period and the first time T1 that is a start time of the third period P3.

Moreover, the first period P1 may be a period from the start time Ts1 to the first time T1. That is, the calculation unit 24 allocates contents according to the attributes to a period from the fuel replenishment start time Ts2 to the first time T1, or to a period from the start time Ts1 to the first time T1.

The second period is a period that includes at least a period from the second time T2, which is an end time of the third period P3, to the end time Te1 of the vehicle stop period. Here, the second period may be any one of a period P2A, a period P2B, a period P2C, and a period P2D. The calculation unit 24 allocates contents according to the attributes to any period among the period P2A, the period P2B, the period P2C, and the period P2D.

The period P2A is a period from the second time T2 to the end time Te1.

The period P2B is a period from the second time T2 to the fuel replenishment end time Te2, which is a time between the second time T2 and the end time Te1.

The period P2C is a period from the fuel replenishment end time Te2 to the end time Te1.

The period P2D is a period from a predetermined time Te3, which is a time between the fuel replenishment end time Te2 and the end time Te1, to the end time Te1.

Here, when the first period P1 is from the start time Ts1 of the vehicle stop period to the first time T1, it is a stage at which charging is started or a time period from the start of charging to an elapse of a certain period of time. For this reason, the passenger of the electric vehicle EV is estimated to be in the stop area T to perform various operations related to charging. Various operations related to charging include, for example, an operation of removing the charging connector of the charger C from the charger C and connecting it to the electric vehicle EV, an operation of inputting an instruction to start charging to the charger C, an operation of registering a method of charge payment, and the like. After the charging operation, the passenger may temporarily return to the vehicle. For this reason, in the first period P1, it is considered that the passenger is present in the stop area T or in the vicinity thereof. In this case, there is a high possibility that the passenger will visually recognizes the display screen of the display device 2. Moreover, when the first period P1 is from the replenishment start time Ts2 to the first time T1, the passenger may return to the vehicle or may be in the vicinity of the vehicle after the charging operation. In this case, there is a high possibility that the passenger will visually recognize the display screen of the display device 2.

Since the second period P2 is a time period in which charging ends, it is estimated that the passenger of the electric vehicle EV is in the stop area T to perform various operations related to the end of charging. Various operations related to the end of charging include, for example, the operation of removing the charging connector of the charger C from the electric vehicle EV and returning it to the charger C, an operation of inputting an end of charging start to the charger C, an operation related to charge payment, and the like. For this reason, in the second period P2, since it is considered that the passenger is present in the stop area T or in the vicinity thereof, there is a high possibility that the passenger will visually recognize the display screen of the display device 2.

For example, when the calculation unit 24 has allocated content to the period P2A, the content can be displayed in a time period before and after the period required for replenishment TR ends. In this case, it is possible to increase a possibility that a passenger who returns to the vehicle before and after a time when charging ends will visually recognize the content.

In addition, when the calculation unit 24 has allocated content to the period P2B, it is possible to increase a possibility that the content will be visually recognized by a passenger who has once gone out of the stop area T after the start of charging and then returns to the vehicle in anticipation of a timing at which the replenishment end time Te2 arrives.

In addition, when the calculation unit 24 has allocated content to the period P2B, it is possible to increase a possibility that the content will be visually recognized by the passenger who has once gone out of the stop area T after the start of charging and then returns to the vehicle in anticipation of the timing at which the replenishment end time Te2 arrives.

In addition, when the calculation unit 24 has allocated content to the period P2C, it is possible to increase a possibility that the content will be visually recognized by a passenger that is present in the vicinity of the stop area T or in the vehicle until the vehicle goes out of the stop area T after returning to the vehicle before and after the replenishment end time Te2.

In addition, when the calculation unit 24 has allocated content to the period P2D, it is possible to increase a possibility that the content will be visually recognized by a passenger who returns to the vehicle after a certain amount of time elapses from the replenishment end time Te2.

Here, a period from the first time T1 to the second time T2 is a period in which a passenger does not have to perform any particular operation related to charging. For this reason, the passenger may go out of the stop area T while continuing charging.

Here, the calculation unit 24 may allocate content whose degree of relevance to the attributes is higher than content allocated to the third period P3 to at least one of the first period P1 and the second period P2. The third period P3 is a period in which the passenger of the vehicle may go out of the stop area T because it is necessary to wait until charging is completed. For this reason, by allocating content whose degree of relevance to the attributes is higher than the content allocated to the third period P3 to at least one of the first period P1 and the second period P2, it is possible to increase a possibility that the content will be visually recognized by the passenger of the vehicle.

In addition, the calculation unit 24 may allocate content whose degree of relevance to the attributes is higher than content allocated to the second period to the first period. Here, the first period has more leisure time remaining in the period required for replenishment than the second period. For this reason, by allocating content whose degree of relevance to the attributes is higher than the content allocated to the second period to the first period, when there is a lot of remaining leisure time, it is possible to provide content that will help to utilize and spend the leisure time. Examples of ways to utilize and spend leisure time include spending time at a restaurant until charging is completed, shopping for vehicle-related products at an automobile parts store in the vicinity of the charging station S, and the like.

The calculation unit 24 calculates the number of contents that can be displayed in the third period P3 on the basis of the third period P3 and a play time of one content, and allocates contents according to the attributes from the content storage unit 27 on the basis of the number of contents. For example, the calculation unit 24 can calculate the number of contents on the basis of Equation (1) described below.

The calculation unit 24 allocates content related to a store located in the vicinity of the charging station S among the contents according to the attributes to the first period. Here, various facilities are located in the vicinity of the charging station S, and a store may be located in some cases. This store may be a store that sells various products, a store that provides various services, or a restaurant.

When a restaurant is located in the vicinity of the charging station S, the calculation unit 24 can also allocate content related to eating and drinking at the restaurant among the contents according to the attributes to the first period.

Here, an operator of the charging station S may also operate the restaurant in the vicinity of the charging station S. Such an operator also requests that a passenger who charges the electric vehicle (EV) at the charging station S spends the period required for replenishment at the restaurant operated by this operator. In such a case, by displaying content related to the restaurant in the first period, a leisure time in the period required for replenishment can be utilized to increase a desire to go to the restaurant.

The image processing unit 25 causes the display screen of the display unit provided at the charging station to display the content extracted by the content extraction unit 23 and allocated by the calculation unit 24 in the vehicle stop period.

The display unit 26 displays various types of information on the display screen. The display unit 26 is, for example, a liquid crystal display panel.

The content storage unit 27 stores various types of content.

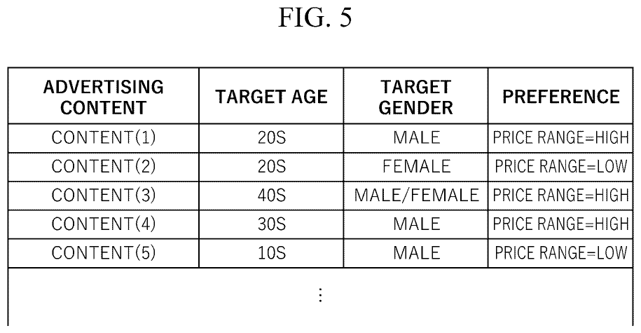

Here, FIG. 5 is a diagram which shows an example of content storage data stored in the content storage unit 27. Content storage data includes an advertising content, a target age, a target gender, and a preference. An advertising content is a content. A target age indicates an age range of a person who wants to view the content. A target gender indicates a gender of the person who wants to view the content. A preference represents a preference of a target user who wants to view the content. In terms of preference, “price range=high” indicates a preference that tends to favor products in a price range that is generally considered to be high, and “price range=low” indicates a preference that tends to favor products in a price range that is generally considered to be low.

For example, when “content(1)” that is an advertising content is viewed by a user whose target age is “20s,” whose target gender is “male,” and whose preference is “price range=high,” the content is expected to have an appealing effect.

Note that although content(1) to content(5) are shown in FIG. 5, other contents may be prepared.

Although a case where the content storage unit 27 is provided inside the display device 2 will be described, it may be provided outside the display device 2. In this case, a storage device having a function of the content storage unit 27 may be communicatively connected to the display device 2, or a server device including the content storage unit 27 may also be communicatively connected to the display device 2 via a network.

The control unit 28 controls each part inside the display device 2.

Next, an operation of the display device 2 described above will be described.

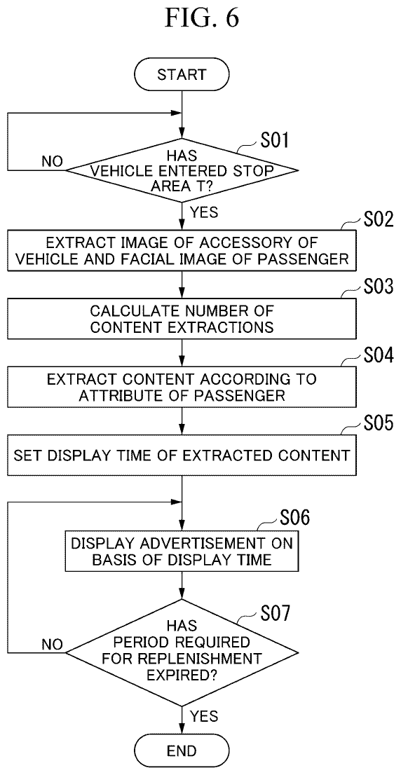

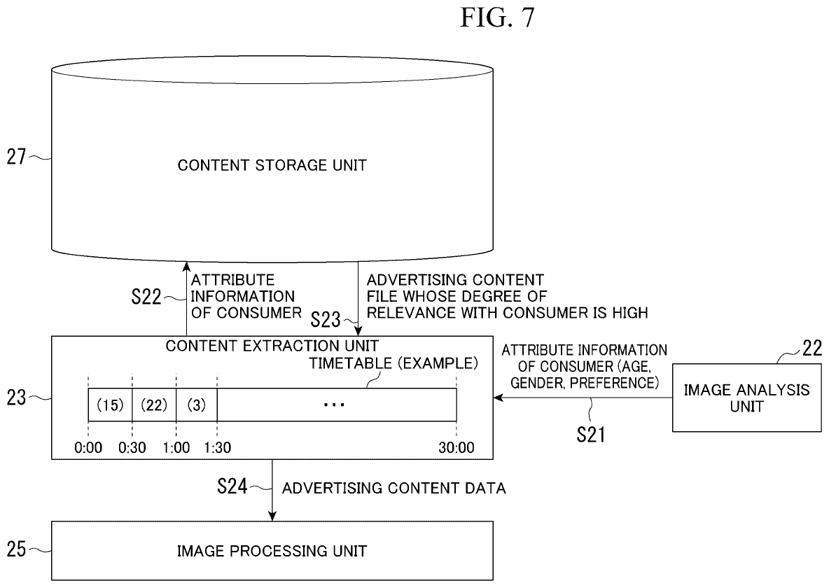

FIG. 6 is a flowchart which describes the operation of the display device 2, and FIG. 7 is a diagram which describes a transaction (a flow) from content extraction to display time setting.

The imaging device 1 images the imaging area R at regular intervals, detects whether a vehicle has entered the stop area T, and when it is detected that a vehicle has entered the stop area T, the imaging device 1 transmits an image in which an entrance of the vehicle is detected to the display device 2. Here, the imaging device 1 may continuously transmit captured images to the display device 2 from when the entrance of the vehicle is detected until when an exit of the vehicle is detected.

The image analysis unit 22 of the display device 2 determines whether the vehicle has entered the stop area T on the basis of whether it has received a captured image from the imaging device 1 (FIG. 6: step S01). For example, when the image analysis unit 22 has received a captured image from the imaging device 1, it determines that the vehicle has entered the stop area T (FIG. 6: YES in step S01), and when the image analysis unit 22 has not received a captured image, it determines that the vehicle has not entered the stop area T (FIG. 6: NO in step S01). When it is determined that the vehicle has not entered the stop area T, the image analysis unit 22 executes step 01 again after a certain period of time elapses.

When the image analysis unit 22 determines that the vehicle has entered the stop area T, it starts measuring a time (for example, 30 minutes) determined as the period required for replenishment, and the processing transitions to step S02 in FIG. 6.

The image analysis unit 22 analyzes the captured image obtained from the imaging device 1, and extracts an image representing an accessory of the vehicle and a facial image of a passenger included in the captured image (FIG. 6: step S02).

The image analysis unit 22 extracts attributes according to the extracted image representing the accessory of the vehicle and facial image of the passenger, and outputs them to the content extraction unit 23 (FIG. 7: step S21).

The content extraction unit 23 refers to the content storage unit 27 on the basis of the extracted attributes (FIG. 7: step S22), and extracts an advertising content whose degree of relevance according to the image representing the accessory of the vehicle and the facial image of the passenger is high (FIG. 7: step S23).

Here, as the number of matches between the extracted image representing the accessory of the vehicle and facial image of the passenger and the attributes stored in the content storage unit 27 increases, the degree of relevance increases.

For example, when the attributes estimated on the basis of the facial image of the passenger are “30s” and “male,” and the attributes estimated on the basis of an emblem of the vehicle are “price range-high,” since the attributes of Content (4) are “30s,” “male,” and “price range=high,” the number of matching attributes is three, and Content (4) is extracted as a content with the highest degree of relevance.

Next, since attributes of Content (1) are “20s,” “male,” and “price range-high,” the number of matching attributes is two, and since attributes of Content (3) are “40s,” “male or female,” and “price range=high,” the number of matching attributes is two, and Content (1) and Content (3) are extracted as contents with the next highest degree of relevance.

In addition, since attributes of Content (5) are “teens,” “male,” and “price range=low,” the number of matching attributes is 1, and Content (5) is extracted as a content with the next highest degree of relevance.

Moreover, since attributes of Content (5) are “20s,” “female,” and “price range-low,” the number of matching attributes is 0, and Content (5) is extracted as a content with the lowest degree of relevance.

The calculation unit 24 prioritizes an advertising content with a high degree of relevance and allocates it to the first period and the second period of the period required for replenishment.

Here, the display device 2 displays content using a free time of the passenger, which is a charging period of the electric vehicle EV, and a free time is, for example, the period required for replenishment, which is about 30 minutes.

For example, when the display time of one advertising content is one minute and the period required for replenishment is 30 minutes, a maximum of 30 advertising contents can be displayed to the passenger during this period required for replenishment.

Here, the calculation unit 24 calculates the number of extractions of advertising contents according to the following equation (1) (FIG. 6: step S03).

The number of extractions of advertising contents=the period required for replenishment/a display time per advertisement (1)

The content extraction unit 23 preferentially extracts the number of extractions of advertising contents calculated by the calculation unit 24 and an advertising content which has a large number of matches with the attributes stored in the content storage unit 27 (target age, target gender, preference) among the attributes that are results of the analysis in step S02 (FIG. 6: step S04).

The calculation unit 24 sets a display time of each of the plurality of advertising contents extracted in step S04 (FIG. 6: step S05). The display time represents a timing at which the content is displayed during an elapsed time from a start to an end of the period required for replenishment.

Here, as obtained in step S03 described above, it is desirable to play up to 30 advertising contents to the passenger so that they can view them, but in some cases, the passenger may go outside the stop area T during charging (go out of the charging station S), or vendors displaying advertising contents (advertisers, companies operating a signage system, and the like) may want the passenger to view the advertising contents when the passenger has a large amount of remaining free time. As the desired situation, for example, there are cases in which the advertiser is a restaurant attached to the charging station, and the advertisement of the restaurant is displayed for the passenger to view before the passenger goes out to another location to attract customers to the restaurant, and the like. The calculation unit 24 can decide the display order of advertisements by taking such cases into consideration.

The calculation unit 24 allocates, to the first period or the second period, an advertising content that has many items matching the attributes of the passenger among the plurality of contents extracted in step S04.

Here, the calculation unit 24 may allocate the advertising content that has many items matching the attributes of the passenger to any one of the first period and the second period, or allocate it to both the first period and the second period.

The calculation unit 24 allocates an advertising content to the first period, which the advertiser desires to display while the passenger has a large amount of remaining free time. This increases a possibility that the passenger who has viewed an advertising content that includes a content attracting people to a restaurant in the first period will determine to use his or her free time and to stop by a restaurant that corresponds to this advertising content. Here, the passenger spends his or her free time in some way, and returns to the vehicle around the charging end time Te, so that the passenger can spend the free time eating and drinking at the restaurant.

In addition, when the advertising content is displayed in the second period, the calculation unit 24 can display the advertising content in consideration of a timing when the passenger returns to the stop area T after going out. Here, in a period between the first period and the second period, there is a possibility that the passenger may be considered to be outside the vehicle, and the passenger may spend time in the vehicle resting and the like even if the passenger is not outside. In this case, it is considered that the passenger is unlikely to visually recognize the display screen of the display device 2. For this reason, when the advertising content is displayed in the second period, it is expected that the passenger will visually recognize the display screen of the display device 2 because the passenger is considered to be inside the stop area T and outside the vehicle.

The calculation unit 24 generates a timetable by setting, as the display time of an advertising content, the plurality of advertising contents extracted from the content storage unit 27 by the content extraction unit 23 in a descending order of the number of items matching the attributes of the passenger. For example, Content (15), Content (22), Content (3), and the like are set in the timetable in order from a start time (0:00) of the period required for replenishment in FIG. 7.

Time points with a high priority may also be set to, for example, fixed values such as five minutes from the start time (0:00) of the period required for replenishment (a first period), a period from 5 minutes before the end time of the period required for replenishment to the end (a second period).

If the setting of the display time of each advertisement content is completed, the calculation unit 24 specifies the display time and outputs each advertising content to the image processing unit 25.

The image processing unit 25 refers to the period required for replenishment whose measurement has started in step S01, and corrects an advertising content according to an elapsed time of the period required for replenishment for displaying an advertisement and causes the display unit 26 to display it on the basis of the display time specified by the calculation unit 24 (FIG. 6: step S06).

Then, the image processing unit 25 refers to the period required for replenishment whose measurement has started in step S01, and determines whether the period required for replenishment has expired (FIG. 6: step S07). The image processing unit 25 continues the display of an advertising content by transitioning to step S06 when the period required for replenishment has not expired (FIG. 6: step S07-NO), and it ends the transaction when it is determined that the period required for replenishment has expired (FIG. 6: YES in step S07). The flowchart shown in FIG. 6 is executed as content display processing for a new vehicle every time the new vehicle arrives at the stop area T.

Next, a second embodiment will be described as another embodiment.

The second embodiment is different from the embodiment described above (the first embodiment) in that there is a third party user U1 who is not the passenger of the electric vehicle EV in addition to the user U0 who is the passenger of the electric vehicle EV, and an advertising content is displayed to the third party (the user U1) in a situation where the user U0 does not view the advertising content in the period required for replenishment.

It is conceivable that the first embodiment is applied when it is assumed that the number of third parties (user U1) is less than a certain number, or when content does not have to be displayed to third parties even if there are more than a certain number of third parties. It is conceivable that the second embodiment is applied when it is assumed that the number of third parties is a certain number or more, or when it can be expected that a third party will arrive.

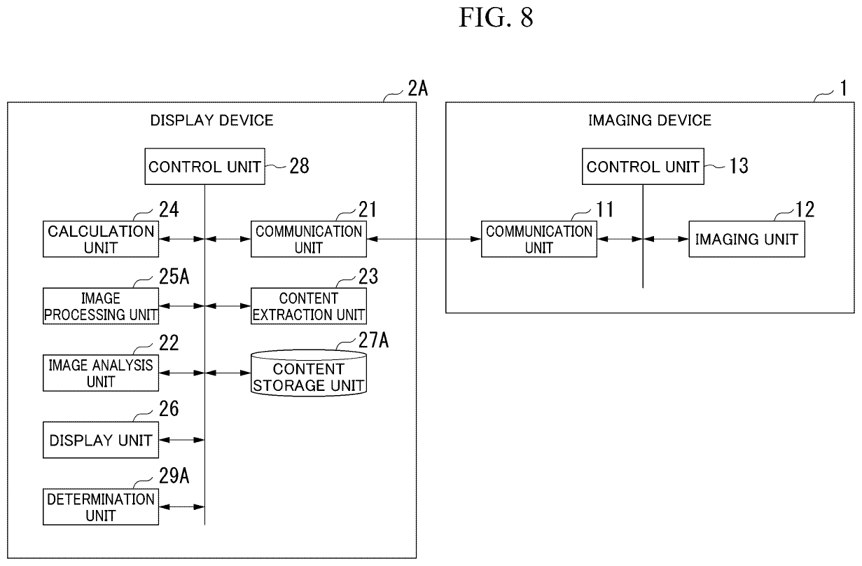

FIG. 8 is a schematic block diagram which describes a configuration of the imaging device 1 and a display device 2A in the second embodiment. In FIG. 8, parts having the same functions as those in the first embodiment are denoted by the same reference numerals as in FIG. 2, and the description thereof will be omitted.

The content storage unit 27A stores advertising content stored by the content storage unit 27 and advertising content (general content) displayed to a third party. The advertising content displayed to a third party may be content provided by a manager of the charging station S or someone other than a manager of the store located in the vicinity of the charging station S and the like (hereinafter referred to as another company). The third party is a person other than the passenger of a vehicle that has entered the stop area T, and is a person in the vicinity of the stop area T.

The determination unit 29A determines whether the passenger of the vehicle that has entered a target area (the stop area T) is absent in the target area on the basis of a captured image. Alternatively, the determination unit 29A may determine whether the passenger of the vehicle that has entered the target area (the stop area T) is in the target area on the basis of the captured image.

When a vehicle has entered the stop area T, when a passenger gets off the vehicle and is present within a range of the stop area T, and until the vehicle in which the passenger has boarded exits the stop area T, since it is estimated that the passenger is in the target area, the determination unit 29A determines that the passenger is not absent (is present in the target area). In some cases, since it is estimated that the passenger is within the stop area T until the vehicle enters the stop area T and the passenger gets off the vehicle even if the passenger is not directly detected from the captured image, or until the passenger boards the vehicle from any position within the stop area T and the vehicle in which the passenger has boarded exits from the stop area T, the determination unit 29A determines that the passenger is within the stop area in such a case.

The determination unit 29A determines that the passenger is absent in the target area when the passenger gets out of the vehicle that has entered the stop area T and then moves outside a range of the stop area T. When the passenger gets out of the vehicle that has entered the stop area T and moves outside the range of the stop area T, it is possible to estimate that the passenger is absent because the passenger is considered to go out in the period required for replenishment.

when it is determined that the passenger is not in the target area, the image processing unit 25A reads content to be browsed by a third party other than the passenger from the content storage unit 27A and causes the display unit 26 to display it. When it is determined that the passenger is in the target area, the image processing unit 25A causes the display unit 26 to display an advertising content allocated by the calculation unit 24A.

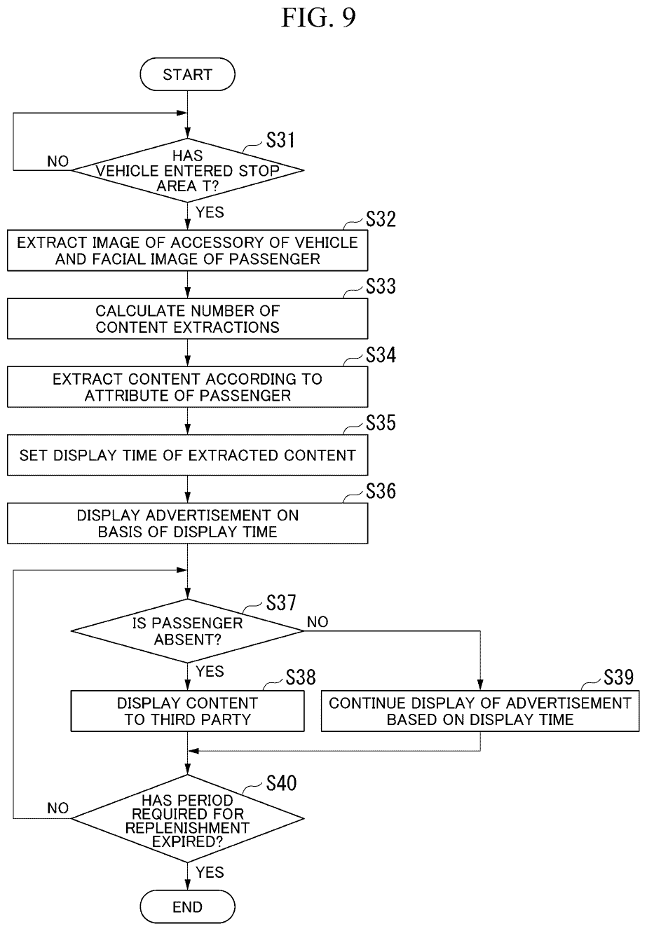

FIG. 9 is a flowchart which describes an operation of the display device 2A in the second embodiment.

Step S31 to step S36 are the same as the processing from step S01 to step S06, so that the description thereof will be omitted.

In step S37, the determination unit 29A determines whether the passenger of a vehicle that has entered a target area is absent in the target area (step S37 in FIG. 9).

When the determination unit 29A determines that the passenger is absent (FIG. 9: YES in step S37), the image processing unit 25A reads content to be browsed by a third party from the content storage unit 27A and causes the display unit 26 to display it (FIG. 9: step S38).

Here, when the passenger cannot be detected from either the vicinity of the charging station S or the driver's seat of the vehicle, it is estimated that the passenger has gone out, so that general content instead of the advertising content set in step S35 is displayed.

Here, since the passenger has gone out, even if content intended for the passenger is displayed, the passenger cannot view it. For this reason, when the user U1 is in the vicinity of the stop area T, since there is a possibility that the user U1 will view a content, a content for the user U1, not intended for the passenger, is displayed. Here, in a case of the user U1, it is considered that the user is not charging the electric vehicle EV and is present in the vicinity of the stop area T. By displaying a general content to such a user U1, it is possible to expect the content to have appealing effect to a third party (the user U1). Additionally, the third period P3 can be used by other companies that provide the general content.

On the other hand, when it is determined that the passenger is not absent in the target area, that is, the passenger is in the target area (FIG. 9: NO in step S37), the image processing unit 25A continues a display of an advertising content based on the display time determined in step S36 (FIG. 9: step S39).

As a result, the image processing unit 25A preferentially causes the display unit 26 to display an advertising content that has a large number of information items matching the attributes of the user U0. Here, an advertising content that has a high degree of relevance with the attributes of the user U0 is displayed in the first period and the second period, and an advertising content that has a lower degree of relevance with the attributes of the user U0 than in the first period and the second period is displayed in the third period. In the third period, the passenger may go out from the stop area T, but may take a break while remaining in the vehicle, so that the passenger may be able to view an advertising content.

After step S38 or after step S39, the image processing unit 25A refers to the period required for replenishment whose measurement has started in step S31, and determines whether the period required for replenishment has expired (FIG. 9: step S40). The image processing unit 25A transitions to step S37 when the period required for replenishment has not expired (FIG. 9: NO in step S40), and it ends the transaction when it is determined that the period required for replenishment has expired (FIG. 9: YES in step S40).

Here, after it is determined that the passenger is absent in step S37 and the content for a third party is displayed, the period required for replenishment has not expired in step S40, the image processing unit 25A transitions to step S37, and the passenger is detected (FIG. 9: NO in step S37), an advertising content based on the display time set in step S36 is displayed.

In the first or second embodiment described above, for example, for a user who purchases automobile supplies, content is used to advertise and promote products or services suitable for the type and condition of a vehicle owned or rented by the user. This makes it possible to improve effectiveness of advertisements and promotion in promoting a purchasing desire.

Furthermore, content-based advertisements and promotions can help a manager of the charging station S to attract customers to his or her store and to increase their purchasing desire, thereby increasing profits of the manager of facilities in the charging station S.

In addition, in the first embodiment or the second embodiment described above, a targeted signage system can be constructed that displays content according to the progress of the period required for replenishment among the contents according to the attributes of the user U1.

Next, a third embodiment will be described.

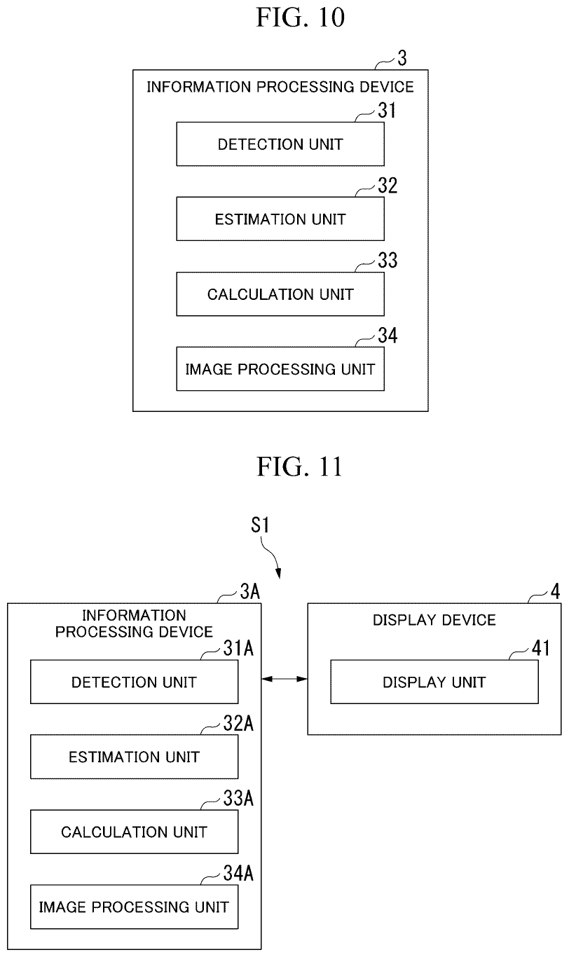

FIG. 10 is a functional block diagram which describes functions of the information processing device 3 in the third embodiment.

The detection unit 31 detects an object that has entered a target area of a charging station based on a captured image of the target area. The target area may be, for example, any area within a facility that is a charging station. The object may be a vehicle or a passenger boarding a vehicle.

The estimation unit 32 estimates the attributes of the detected object.

The calculation unit 33 allocates contents according to the attributes to at least one of the first period, which is a period from the charging start time to the first time, and the second period, which is a period from the charging end time to the second time in the period required for replenishment for a vehicle that has entered the target area.

In the period required for replenishment, the image processing unit 34 causes the allocated contents to be displayed on the display screen of the display unit provided at the charging station. The display unit may be a display device connected to an outside of the information processing device 3, or when a display unit is mounted on the information processing device, it may be the mounted display unit.

Next, a fourth embodiment will be described.

FIG. 11 is a functional block diagram which describes functions of the content display system S1 in the fourth embodiment.

The content display system S1 includes an information processing device 3A and a display device 4.

The information processing device 3A includes a detection unit 31A, an estimation unit 32A, a calculation unit 33A, and an image processing unit 34A. The detection unit 31A, the estimation unit 32A, the calculation unit 33A, and the image processing unit 34A correspond to the detection unit 31, the estimation unit 32, the calculation unit 33, and the image processing unit 34 in the third embodiment, respectively, and have the same functions. Therefore, the description thereof will be omitted.

The display device 4 is, for example, a liquid crystal display device. The display device 4 includes a display unit 41. The display unit 41 displays content output from the image processing unit 34A.

The information processing device 3 and the information processing device 3A described above are computers, and the functions described above may be realized by a dedicated electronic circuit, or realized by a CPU provided in the information processing device 3 executing a software program.

Moreover, construction management may be performed by recording at least one of programs for realizing functions of the display device 2 in FIG. 2, the display device 2A in FIG. 8, and the information processing device 3 in FIG. 10 on a computer-readable recording medium, causing a computer system to read the program recorded in this recording medium, and executing it. Note that the term “computer system” here includes an OS and hardware such as peripheral devices.

In addition, the “computer system” includes a homepage providing environment (or display environment) if a WWW system is used.

Moreover, the “computer-readable recording medium” refers to a portable medium such as a flexible disk, a magneto-optical disc, an ROM, or a CD-ROM, or a storage device such as a hard disk embedded in the computer system. Furthermore, examples of “computer-readable recording medium” include those that retain programs for a certain period of time, such as a volatile memory inside a computer system serving as a server or a client. Moreover, the program described above may be a program for realizing a part of the functions described above, or may be a program that can realize the functions described above in combination with a program already recorded in the computer system. Furthermore, the program described above may be stored in a predetermined server, and the program may be distributed (downloaded, or the like) via a communication line in response to a request from another device.

Although the embodiments of the present invention have been described above in detail with reference to the drawings, a specific configuration is not limited to these embodiments, and includes designs within a range not departing from the gist of the present invention.

### REFERENCE SIGNS LIST

1 Imaging device
2, 2A Display device
3, 3A Information processing device
4 Display device
11, 21 Communication unit
12 Imaging unit
13 Control unit
22 Image analysis unit
23 Content extraction unit
24, 24A Calculation unit
25, 25A Image processing unit
26 Display unit
27, 27A Content storage unit
28 Control unit
29A Determination unit
31, 31A Detection unit
32, 32A Estimation unit
33, 33A Calculation unit
34, 34A Image processing unit
41 Display unit

What is claimed is:

1. An information processing device comprising:
a detection unit configured to detect an object that has entered a target area;
an estimation unit configured to estimate attributes according to the detected object;
a calculation unit configured to allocate contents according to the attributes to at least one period among an intermediate period that is a part of a vehicle stop period in which a vehicle stops in the target area for replenishment of an energy source, a first period including a period from at least a replenishment start time Ts2, which is a time between a start time Ts1 of the vehicle stop period and a first time T1, to the first time T1, between the start time Ts1 and the first time T1, that is a start time of the intermediate period, and a second period that includes at least a period from a second time T2, which is an end time of the intermediate period, to an end time Te1 of the vehicle stop period; and
an image processing unit configured to cause the allocated contents to be displayed on a display screen of a display unit provided at a position corresponding to the target area in the vehicle stop period.

2. The information processing device according to claim 1,
wherein the detection unit is configured to detect an object that has entered the target area from a captured image of a charging station.

3. The information processing device according to claim 1,
wherein the calculation unit is configured to allocate the content using a period from the start time Ts1 to the first time T1 as a first period.

4. The information processing device according to claim 1,
wherein the calculation unit is configured to allocate the content using any one period of a period P2A from the second time to the end time Te1, a period P2B from the second time to a replenishment end time Te2, which is a time between the second time and the end time Te1, a period P2C from the replenishment end time Te2 to the end time Te1, and a period P2D from a predetermined time Te3, which is a time between the replenishment end time Te2 and the end time Te1, to the end time Te1 as a second period.

5. The information processing device according to claim 1,
wherein the calculation unit is configured to allocate content whose degree of relevance to the attributes is higher than content allocated to the intermediate period to at least one of the first period and the second period.

6. The information processing device according to claim 5,
wherein the calculation unit is configured to allocate content whose degree of relevance to the attributes is higher than content allocated to the second period to the first period.

7. The information processing device according to claim 1,
wherein the calculation unit is configured to obtain the number of contents that are displayable within the intermediate period on the basis of the intermediate period and a play time of one content, and allocates contents according to the attributes from a storage unit that stores content on the basis of the number of contents.

8. The information processing device according to claim 1,
wherein the estimation unit is configured to estimate attributes on the basis of at least one of a vehicle that has entered the target area, an accessory attached to the vehicle, and a face of a passenger of the vehicle.

9. The information processing device according to claim 1, further comprising:
a determination unit configured to determine whether a passenger of a vehicle that has entered the target area is in the target area,
wherein the image processing unit is configured to, when it is determined that the passenger is not in the target area, display content read from a storage unit that stores the content a third party different from the passenger is caused to browse.

10. The information processing device according to claim 1,
wherein the calculation unit is configured to allocate content related to a store in the vicinity among contents according to the attributes in the first period.

11. The information processing device according to claim 10,
wherein the store is a restaurant, and
the calculation unit allocates content relates to eating and drinking at the restaurant among the contents according to the attributes in the first period.

12. A content display system comprising an information processing device and a display device at a charging station,
wherein the information processing device comprises:
a detection unit configured to extract a target area from a captured image of a charging station and detect an object that has entered a target area,
an estimation unit configured to estimate attributes according to the detected object,
a calculation unit configured to allocate contents according to the attributes to at least one period among an intermediate period that is a part of a vehicle stop period in which a vehicle stops in the target area for replenishment of an energy source, a first period including a period from at least a replenishment start time Ts2, which is a time between a start time Ts1 of the vehicle stop period and a first time T1, to the first time T1, between the start time Ts1 and the first time T1, that is a start time of the intermediate period, and a second period that includes at least a period from a second time T2, which is an end time of the intermediate period, to an end time Te1 of the vehicle stop period, and
an image processing unit configured to cause the allocated contents to be displayed on a display screen of a display device provided at a position corresponding to the target area in the vehicle stop period, and
wherein the display device comprises a display unit configured to display content output from the information processing device.

13. An information processing method executed by a computer, the method comprising:
detecting an object that has entered a target area from a captured image of the target area of a charging station;
estimating attributes according to the detected object;
allocating contents according to the attributes to at least one period among an intermediate period that is a part of a vehicle stop period in which a vehicle stops in the target area for replenishment of an energy source, a first period including a period from at least a replenishment start time Ts2, which is a time between a start time Ts1 of the vehicle stop period and a first time T1, to the first time T1, between the start time Ts1 and the first time T1, that is a start time of the intermediate period, and a second period that includes at least a period from a second time T2, which is an end time of the intermediate period, to an end time Te1 of the vehicle stop period; and
causing the allocated contents to be displayed on a display screen of a display unit provided at a position corresponding to the target area in the vehicle stop period.
